(19) United States
(12) Patent Application Publication
(10) Pub. No.: US 2008/0263573 A1
(43) Pub. Date: Oct. 23, 2008

(54) Optical Disc Drive

(75) Inventors: Karel Gerardus Maria Koken, Eindhoven (NL); Myriam Sabine Josee Splets, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,097

(22) PCT Filed: Mar. 14, 2006
(86) PCT No.: PCT/IB2006/050783

§ 371 Date: Sep. 19, 2007

(30) Foreign Application Priority Data
Mar. 24, 2005 (EP) 05102402.4

(51) Int. Cl. G11B 17/04

(52) U.S. Cl. 720/600

(57) ABSTRACT

An optical disc drive, comprising a mounting frame (4) and an optical pickup unit (2), the frame comprising a guide mechanism (3, 3′) which is configured to guide the optical pickup unit towards at least one end position with respect to the frame. The disc drive comprises at least one first stop (6, 6′, 6″, 6′″) which is configured to gradually slow down movement of the optical pickup unit when that unit approaches the at least one end position. The disc drive further comprises at least one second stop (7, 7′, 7″) which is configured to stop movement of the optical pickup unit with respect to the frame abruptly after that unit has been slowed down over a first predetermined distance by a respective first stop.

The invention relates an optical disc drive, comprising a mounting frame and an optical pickup unit, the frame comprising a guide mechanism which is configured to guide the optical pickup unit towards at least one end position with respect to the frame, wherein the disc drive comprises at least one first stop which is configured to gradually slow down movement of the optical pickup unit when that unit approaches the at least one end position.

An optical disc drive of the above kind is known from KR 2004028032 A, which is incorporated herein by reference.

During shipping and assembly processes, an optical disc drive may experience high levels of shock. Optical disc drives, in particular certain components of the drives, for instance a spindle motor and an optical pickup unit, are very sensitive to shock. Non-operational shock specifications are emphasized, because even the slightest shock is capable of damaging. Another continuing trend in the industry is the reduction in size of optical disc drives. Components are placed closer to each other, providing narrower gaps between the components. Such narrow vertical spacing of the components gives rise to a problem of increased sensitivity of optical disc drives to non-operational, mechanical shocks.

In KR 2004028032 A, first stoppers are provided. These first stoppers firstly contacted with the optical pickup along the driving direction of the optical pickup. Second stoppers are contacted with the optical pickup after a predetermined delay from contact at the first stoppers.

Due to further developments in the optical disc drive industry, for example the blue disc mechanism comprising three laser branches, the combination, dimensions and spacing of the components are changing. For example in a blue disc mechanism, the optical pickup head can be larger, wider and heavier than the optical pick up head of the known optical disc drive. As a result, more acceleration can arise in case of a non-operational shock.

Besides, another development in the optical disc drive industry is a lightscribe function of the optical disc drive. Lightscribe enables the optical disc drive, using laser energy, to apply text or pictures to the top layer of the disc, for example making paper etiquettes redundant. However, there is only little space available in the disc drive to install a lightscribe mechanism.

In many cases, the known protecting mechanism is not sufficient to prevent damage of components of the disc drive, particularly in case of miniaturization of the drive, and/or in case of an increase of weight and/or dimensions of the optical pickup unit.

It is an object of the invention to improve the optical disc drive. More particularly, the invention aims to provide an optical disc drive suitable for multiple laser branches and/or suitable for lightscribe, wherein damage of components can be prevented well, for example damage due to non-operational shock. Another object of the invention is to provide mechanical shock protection in an easily implemented and cost effective manner.

According to the present invention, the disc drive is characterized in that the disc drive comprises at least one second stop which is configured to stop movement of the optical pickup unit with respect to the frame abruptly after that unit has been slowed down over a first predetermined distance by a respective first stop.

When a shock is applied to the optical disc drive, one or more first stops will slow down the optical pickup unit gradually. One or more second stops can take care of the remaining speed abruptly, resulting in a total standstill of the optical pickup unit within a small distance. Thus, damage to components of the disc drive can be prevented well, for example damage due to bumping or dropping, or other types of non-operational shock events. Disc drive components that can be protected by the stops can include: a spindle motor, an optical pickup unit, laser branches, a crankshaft, or other components. Damage to or failure of any of these components may result in reduced liability or failure of the disc drive. Spindle damage, for instance, can lead to spindle motor failure. The enhancements of the invention help tot increase the drives resistance to non-operational shocks.

According to an aspect of the invention, each first stop can be a soft stop that is made of resilient material, wherein each respective second stop can be a hard stop that is made of rigid material.

In that case, during use, when the optical pickup unit touches a soft stop, that stop can resiliently deform or compress, thus slowing down the pickup unit. The second, hard, stop can absorb the remaining kinetic energy. An important advantage of the combination of soft stops and hard stops lies in the fact that on the one hand the optical pickup unit is not stopped immediately because the capability of the soft stop to compress. On the other hand, the hard stop can take care of subsequent immediate stopping of the optical pickup unit, for example to determine a maximum stroke movement of the optical pickup unit towards other components of the optical disc drive.

According to an aspect of the invention, said first stop can be connected to said second stop. As an example, a hard stop can be partially surrounded by a soft stop. Also, the shape of the first stop can match the shape of the second stop, providing tightly wrapping of the first stop around the second stop. This brings along easy assembly, thus reducing assembly time and therefore reducing costs.

According to a further aspect of the present invention, the optical disc drive comprises at least two first stops to gradually slow down movement of the optical pickup unit when that unit approaches the at least one end position, such, that one of the first stops start slowing down the optical pickup unit movement after that unit has been slowed down over a second predetermined distance by the other of the first stops. Such arrangement of stops can provide a certain distribution of a total impact during use, wherein shock forces can be distributed among the various stops.

According to the invention, said stops can be positioned at or near four corners of an aperture in the mounting frame, for example an aperture through which the optical pickup unit is displaceable during use. By providing the second and first stops at or near four corners of the aperture in the mounting frame, the optical pickup unit can be protected against non-operational shocks from several directions.

For example, during use, the optical pickup unit may move with a certain speed towards a spindle of the disc drive. Then, to avoid damage, an assembly of first and second stops can bring off a phased slowing down of the pickup unit. For example, first, the optical pickup unit contacts a first stop mounted near a first aperture corner of the mounting frame aperture. That first stop will start slowing down the pickup unit gradually. Shortly thereafter, after said second predetermined distance, the optical pickup unit may hit another first stop, that is mounted near an opposite aperture corner. This other first stop will also initiate a gradual slowing down of the pickup unit. Then after said first predetermined distance, the optical pickup unit can hit a second stop, which is installed, for example, near the first corner of the mounting frame aperture as well. The second stop will instantly stop the optical pickup unit. To avoid a rotation of the pickup unit, and/or related bending of the guiding mechanism, another second stop can be located at the opposite aperture corner, to instantly stop the optical pickup unit as well after a first predetermined distance.

The second stop can be constructed in various ways, for example, from a suitable material which will provide a suitable mechanical strength to stop the optical pickup unit promptly, to absorb the remaining kinetic energy and/or to avoid undesired deformation of the second stop. According to the invention, said second stop can be of a solid material. For example, the second stop can determine a minimum space between the optical pickup unit and other components of the optical disc drive, when the optical pickup unit is in an end position.

According to the invention, said second stop can be an integral part of the mounting frame. The second stop can be attached to the mounting frame during assembly of the optical disc drive, but can also be a part of the mounting frame, depending on the form, dimensions and the location of the second stop. An advantage of the second stops being a part of the mounting frame is that the manufacture is relatively easy and therefore advantageous regarding time and costs.

According to the invention, said first stop can be of rubber or a rubber-like material. Also, a first stop can comprise a suitable spring. The first stop can be for example of any material that has the capacity to compress when a certain force is applied.

Further advantageous aspects of the invention are described in the claims.

The invention will be further elucidated by means of an exemplary embodiment with reference to the accompanying drawing in which:

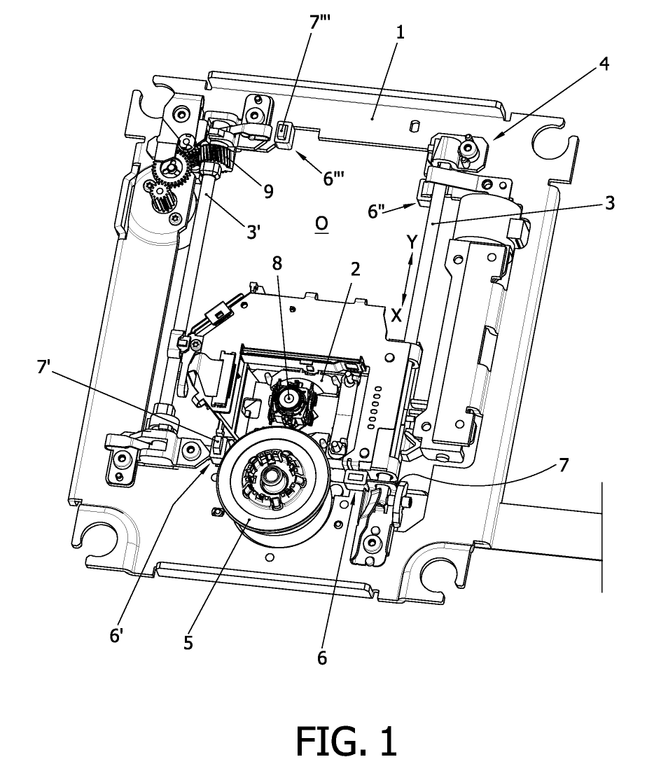

FIG. 1 is a perspective view of an embodiment of the invention;

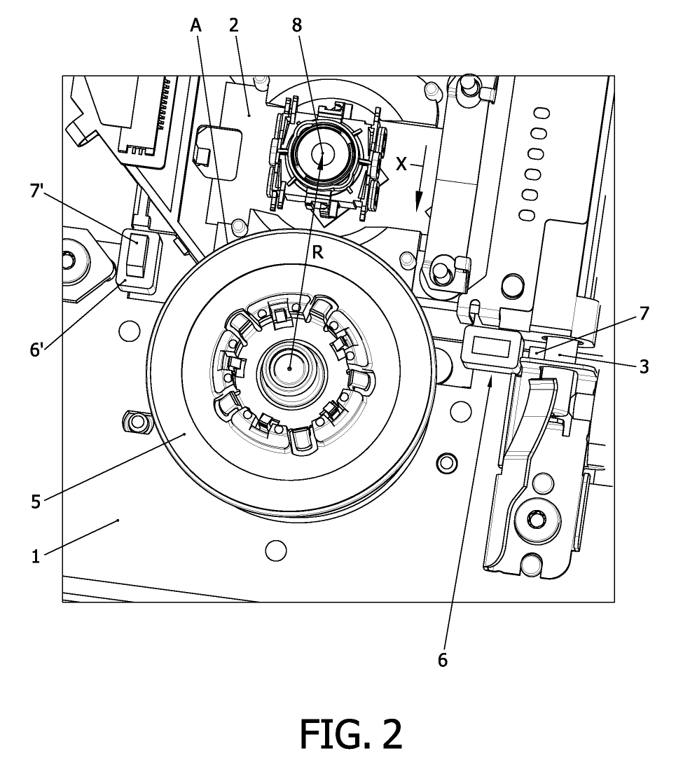

FIG. 2 is a more detailed perspective view of FIG. 1;

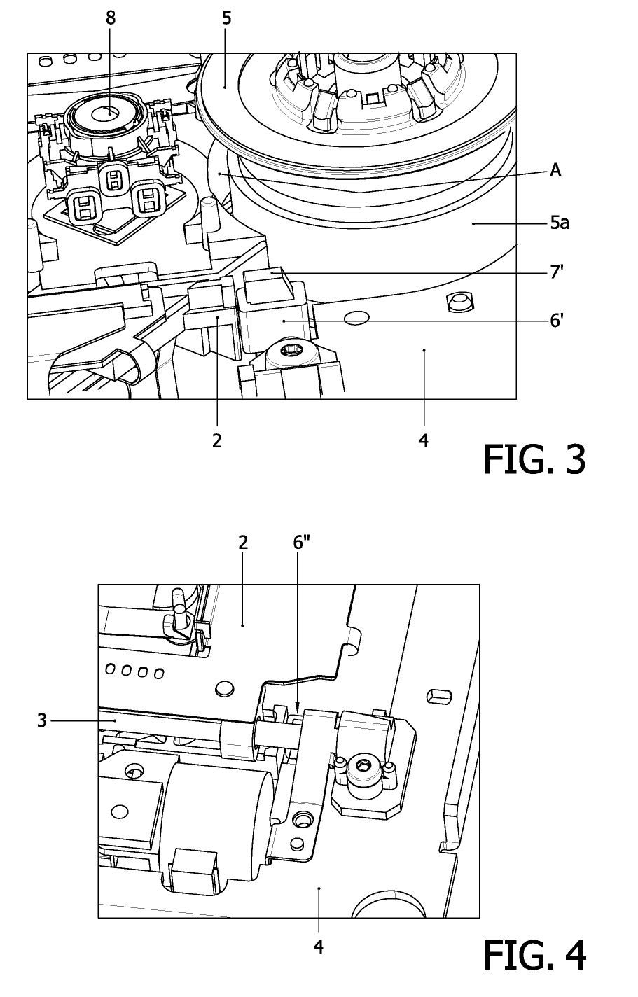

FIG. 3 is a more detailed perspective view of FIG. 1;

FIG. 4 is a more detailed perspective view of FIG. 1 from a different angle;

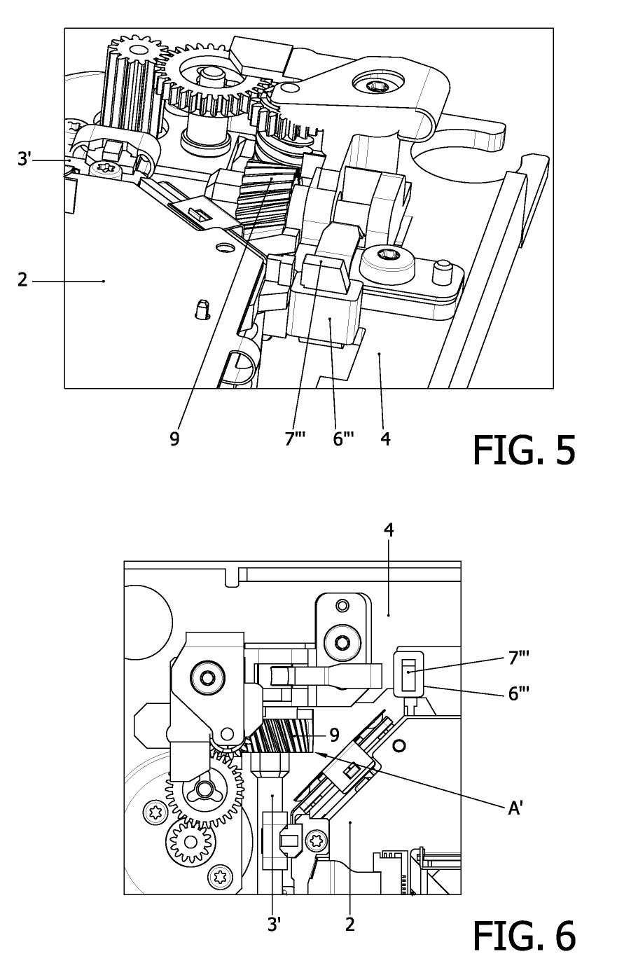

FIG. 5 is a detailed perspective view of FIG. 1 from again a different angle; and

FIG. 6 is a top view of FIG. 5.

In the present application, equal or similar parts have equal or similar reference signs.

FIG. 1 shows part of an optical disc drive 1, particularly for blue laser applications. The drive 1 can be used, for example. for reading information from and/or writing information to an optical information carrier.

The optical disc drive 1 comprises an optical pickup unit 2, two guide bars 3, 3′, a mounting frame of mounting plate 4 having an aperture O through which the pickup unit 2 can be guided, and a spindle 5 for rotating the disc (not shown in the drawing). Said optical pickup unit 2 holds a lens and three laser branches (not visible), emitting infrared laser, red laser or blue laser. The guide bars 3, 3′ are arranged for guiding the optical pickup unit 2 between two opposite end positions. A driving mechanism of the disc drive includes a crankshaft 9. This driving mechanism is configured to move the optical pickup unit 2 in a first direction X towards a first end position near the spindle 5, and in a second direction Y away from the spindle 5, towards a second end position near the crankshaft 9, along the guide bars 3, 3′.

In operation, the optical pickup unit 2 preferably is able to approach spindle 5 very closely, for example in order to lightscribe a disc. In such a position, and for example due to a non-operational shock, the optical pickup unit 2 might hit the spindle 5, resulting in possible damage of the components of the optical disc drive 1. To prevent such damage, an arrangement of four soft stops 6, 6′, 6″, 6′″ and three hard stops 7, 7′, 7′″, is provided.

A first and second soft stop 6, 6′ are configured to gradually slow down movement of the optical pickup unit 2 when that unit 2 approaches the first end position. A third and fourth soft stop 6″, 6′″ are configured to gradually slow down movement of the optical pickup unit 2 when that unit 2 approaches the second end position.

The optical disc drive 1 of the present embodiment comprises a number of hard stops 7, 7′, 7′″, each of which is configured to stop movement of the optical pickup unit 2 with respect to the frame 4 abruptly after that unit 2 has been slowed down over a first predetermined distance by a respective soft stop 6, 6′, 6″, 6′″. For example, the first predetermined distance can be smaller that about 1 mm, and particularly in the range of about 0.6-0.7 mm.

A first and second hard stop 7, 7′ are configured to abruptly down movement of the optical pickup unit 2 when that unit 2 reaches the first end position. The first hard stop 7 is configured to stop movement of the optical pickup unit 2 with respect to the frame 4 abruptly after that unit 2 has been slowed down over a first predetermined distance by the first soft stop 6. The second hard stop 7′ is configured to stop movement of the optical pickup unit 2 with respect to the frame 4 abruptly after that unit 2 has been slowed down over a first predetermined distance by the second soft stop 6′. For example, in each case, the first predetermined distance can be smaller that about 1 mm, and particularly in the range of about 0.6-0.7 mm.

A third hard stop 7′″ is configured to stop movement of the optical pickup unit 2 with respect to the frame 4 abruptly after that unit 2 has been slowed down over another first predetermined distance by the fourth soft stop 6′″. Also in that case, for example, the first predetermined distance can be smaller that about 1 mm, and particularly in the range of about 0.6-0.7 mm.

In the present embodiment, the hard stops 7, 7′, 7′″ are part of the mounting frame 4. The first hard stop 7 is a mounting frame part 7 that is located at a small distance next to the first soft stop 6. The second hard stop 7′ and third hard stop 7′″ are partially surrounded by the second soft stop 6′ and the fourth soft stop 6′″, respectively. On the other hand, the hard stops can also be separate parts that are connected to the mounting frame 4.

The first stops 6, 6′, 6″, 6′″ and second stops 7, 7′, 7′″ can be placed in line with the guide bars 3, 3′, or near ends of the guide bars or at other suitable locations.

Also, in the present example, the first and second soft stop 6, 6′ are arranged such, that second soft stops 6′ starts slowing down the optical pickup unit 2 movement after that unit 2 has been slowed down over a second predetermined distance by the first soft stop 6. Besides, in the present example, the third and fourth soft stop 6″, 6′″ are arranged such, that the fourth soft stops 6′″ starts slowing down the optical pickup unit 2 movement after that unit 2 has been slowed down over a second predetermined distance by the third soft stop 6″. In each case, for example, the second predetermined distance is about 1 mm or smaller, particularly about 0.5 or smaller, more particularly about 0.2 mm.

The soft stops 6, 6′, 6″, 6′″ and hard stops 7, 7′, 7′″ are configured to slow down and eventually stop the optical pickup unit 2 one by one. As follows from the above, delays are provided between the different stops to gradually slow down the optical pickup unit 2. The delays can be smaller than 1 mm, for example in the range between 0.1 mm and 0.7 mm.

Furthermore, the stops 6, 7, 6′, 7′, 6″, 6′″, 7′″ are mounted near opposite corners of the aperture O of the mounting frame 4, to prevent the optical pickup unit 2 from turning in the horizontal plan due to non-operational shock.

FIG. 2 shows a more detailed view of the optical disc drive 1. In this figure, the optical pickup unit 2 is positioned near the spindle 5. In this position, when the optical disc (not shown) is situated on the spindle 5, the laser lens 8 can lightscribe text or pictures on the topside of the disc. For example, for lightscribe, the laser lens 8 has to be distanced in a small radius R from the centre of the optical disc. In that case, a respective minimum gap A between the optical pickup unit 2 and the spindle 5 is relatively small. The first and second soft stop 6, 6′ and first and second hard stop 7, 7′ can protect against collision, when the unit 2 is near the spindle 5.

As is shown in FIGS. 2 and 3, during use, when the optical pickup unit 2 approaches the first end position, it will be stopped by the first soft stop 6, at a right front side of the mounting frame aperture O. After—for example—about 0.2 mm, the unit 2 will be stopped by the second soft stop 6′, at a left front side of the mounting frame aperture O. In that way, accelerations of the unit 2 can slowly phase out and not at a blow. Due to compression of the soft stops 6, 6′, the optical pickup unit 2 can still move further towards the spindle 5. After, for example, about 0.6 mm after the first soft stop 6, the sledge of the pickup unit 2 hits the first hard stop 7 of the mounting frame 4, at the right front side of the mounting frame aperture O. Then, rotation of the optical pickup unit 2 is avoided by the second hard stop 7′, which is located, for example, about 0.7 mm after the second soft stop 6′. In this way, the inner radius of the optical pickup unit 2 can be made relatively small, whereas damage of drive components can still be prevented well.

FIG. 4 shows a detail of FIG. 1 from another angle, at the opposite side of the mounting frame 4. The optical pickup unit 2 is now positioned at the other ends of the guide bars 3, 3′, touching the third and fourth soft stop 6″, 6′″. Also at this side of the mounting frame 4, it is clear that the optical pickup unit comes very close to the crankshaft when a non-operational shock would take place.

During use, when the optical pickup unit 2 approaches the second end position (near the crankshaft 9), the unit 2 hits the third soft stop 6″ first, at the right back side of the mounting frame aperture O. After a small distance, for example about 0.1 mm, the unit 2 hits the fourth soft stop 6′″. The third and fourth soft stop 6″, 6′″ gradually slow down the pickup unit 2. The unit 2 can still move further towards the second end position, under compression of the soft stops 6″, 6′″. However, after a predetermined distance after the fourth soft stop 6′″, for example after about 0.7 mm, the optical pickup unit 2 hits a respective third hard stop 7′″, at the left back side of the mounting frame 4.

The third soft stop 6″ may also be associated with a respective fourth hard stop (not shown), in contrary to the above.

FIG. 6 shows top view of FIG. 5. Herein, it is clearly seen that the optical pickup unit 2 can remain at a certain distance A′ from the crankshaft 9. Therefore, the crankshaft 9 can drive the guide bar 3′ without any obstructions, and without being hindered by the optical pickup unit 2.

As mentioned above, and although not shown in the drawings, it will be recognized that another advantage of the described arrangement of soft stops 6, 6′, 6″,6′″ and hard stops 7, 7′, 7′″ is, that these stops protect the guide bars 3, 3′ against bending due to non-operational shock. When such stops were not installed, the optical pickup unit 2 could hit another component at one end of a guide bar 3, at a side of the mounting frame 4. In that case, the optical pickup unit 2 could tend to turn due to impact forces applied thereto. Such a turning would risk a bending of the guide bars 3, causing a failure in driving the optical pickup unit 2 along the guide bars 3, 3′. The present invention can avoid such turning of the pickup unit 2 and, consequently, provides a durable disc drive.

Although an illustrative embodiment of the present invention has been described in greater detail with reference to the accompanying drawing, it is to be understood that the invention is not limited to the embodiment. Various changes or modifications may be effected by one skilled in the art without departing from the scope or the spirit of the invention as defined in the claims.

For instance, modifications with respect to locations of the first and second stops, the construction of the first and second stops and the kind of material used for the first and second stops are meant to be covered by the invention. Also one or more first stops can be connected to the optical pickup unit. The same holds for the second stops.

1. An optical disc drive, comprising a mounting frame (4) and an optical pickup unit (2), the frame (4) comprising a guide mechanism (3, 3′) which is configured to guide the optical pickup unit (2) towards at least one end position with respect to the frame (4), wherein the disc drive (1) comprises at least one first stop (6, 6′, 6″, 6′″) which is configured to gradually slow down movement of the optical pickup unit (2) when that unit (2) approaches the at least one end position, wherein the disc drive (1) comprises at least one second stop (7, 7′, 7′″) which is configured to stop movement of the optical pickup unit (2) with respect to the frame (4) abruptly after that unit (2) has been slowed down over a first predetermined distance by a respective first stop (6, 6′, 6″, 6′″).

2. An optical disc drive according to claim 1, wherein each first stop (6, 6′, 6″, 6′″) is a soft stop that is made of resilient material, wherein each respective second stop (7, 7′, 7′″) is a hard stop that is made of rigid material.

3. An optical disc drive according to claim 1, wherein said first predetermined distance is smaller than about 1 mm, wherein said first predetermined distance is particularly in the range of about 0.6-0.7 mm.

4. An optical disc drive according to claim 1, comprising at least two first stops (6, 6′, 6″, 6′″) to gradually slow down movement of the optical pickup unit (2) when that unit (2) approaches the at least one end position, such, that one of the first stops (6′, 6′″) starts slowing down the optical pickup unit (2) movement after that unit (2) has been slowed down over a second predetermined distance by the other of the first stops (6, 6″).

5. An optical disc drive according to claim 4, wherein the second predetermined distance is about 1 mm or smaller, particularly about 0.5 or smaller, more particularly in the range of about 0.1-0.2 mm.

6. An optical disc drive according to claim 1 comprising at least one guide bar (3, 3′) for guiding the optical pickup unit (2), and a mechanism (9) for moving the optical pickup unit (2) back and forth along said guide bar (3, 3′) towards two opposite end positions.

7. An optical disc drive according to claim 1, wherein said first stop (6′, 6′″) is partially surrounded by said second stop (7′, 7′″).

8. An optical disc drive according to claim 1, comprising at least four first stops (6, 6′, 6″, 6′″) and three respective second stops (7, 7′, 7′″).

9. An optical disc drive according to claim 1, wherein said first stops (6, 6′, 6″, 6′″) and second stops (7, 7′, 7′″) are placed in line with the guide bars (3, 3′), or near ends of the guide bars.

10. An optical disc drive according to claim 1, wherein said stops (6, 7, 6′, 7′, 6″, 6′″, 7′″) are positioned at or near four corners of an aperture in the mounting frame (4).

11. An optical disc drive according to claim 1, wherein said second stop (7, 7′, 7′″) consists of a solid material.

12. An optical disc drive according to claim 1, wherein said second stop (7, 7′, 7′″) is part of the mounting frame (4).

13. An optical disc drive according to claim 1, wherein said first stop (6, 6′, 6″, 6′″) consists of rubber or a rubber-like material.

14. An optical disc drive according to claim 1, wherein the at least one first stop (6, 6′, 6″, 6′″) and one second stop (7, 7′, 7′″) are configured to prevent the optical pickup unit (2) from colliding with other components of the optical disc drive (1) when moving towards said end position.

15. Optical disc drive (1) according to claim 1, wherein the optical pickup unit (2) comprises three laser branches, for example infrared, red and blue laser branches.

16. Use of an optical disc drive according to claim 1 for reading information from and/or writing information to an optical information carrier.
